(19) United States
(12) Patent Application Publication
(10) Pub. No.: US 2010/0272960 A1
(43) Pub. Date: Oct. 28, 2010

(54) MOLDED BODY HAVING MATT AND STRUCTURED SURFACE PROPERTIES

(75) Inventors: Klaus Schultes, Wiesbaden (DE); Sabine Schwarz-Barac, Riedstadt (DE); Klaus Albrecht, Mainz (DE); Ursula Golchert, Dieburg (DE); Stefan Nau, Buettelborn (DE); Sabrina Thomas, Biblis (DE); Michael Schnabel, Biebesheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/738,033

(22) PCT Filed: Aug. 29, 2008
(86) PCT No.: PCT/EP08/61352

§ 371 Date: Apr. 14, 2010

(30) Foreign Application Priority Data
Dec. 10, 2007 (DE) 10 2007 059 632.6

(51) Int. Cl. B32B 3/30; C08L 33/12

(52) U.S. Cl. 428/156; 525/55

(57) ABSTRACT

Composition for the production of mouldings having a matt and structured surface character, comprising a polymer matrix and crosslinked polymer particles, the polymer matrix comprising at least one acrylic polymer and the composition containing
(i) first crosslinked polymer particles having a volume average of the particle size in the range from 30 μm to 1500 μm and
(ii) second crosslinked polymer particles having a volume average of the particle size of less than 30 μm,
   the difference between the refractive index of the first polymer particles and the refractive index of the polymer matrix, measured in each case at 25° C., being less than 0.015 as an absolute value and the difference between the refractive index of the second polymer particles and the refractive index of the polymer matrix, measured at 25° C., being greater than or equal to 0.015 as an absolute value.

The mouldings of the invention are suitable in particular for use as components for lighting, signs and symbols, points-of-sale, cosmetics display stands, containers, home and office decoration, furniture applications, shower cabinet doors and office doors.

The present invention relates to a composition for the production of mouldings having a matt and structured surface character, the mouldings obtainable from such a composition and the use thereof.

For lighting and illumination applications, points-of-sale and cosmetics display stands, there is a permanent demand for novel and innovative products which are visually as appealing as possible and at the same time can be produced as economically as possible. What is desirable in particular is a plastics product which imitates the properties and the appearance of sand-blasted glass as well as possible.

Production of such plastics in a conventional manner, for example by surface treatment, such as sand blasting and the production of surface patterns, and by means of addition of inorganic fillers and additives, such as barium sulphate, calcium carbonate, titanium dioxide, silica, etc., is suitable only to a limited extent for this purpose. Firstly, this procedure is extremely complicated and expensive. In addition, uniform dispersion of inorganic fillers within a polymer matrix can generally only be poorly effected. Moreover, they reduce the light transmittance of the polymer to a great extent and do not lead to the desired surface texture or character. Furthermore, such fillers adversely affect the physical properties of the polymer.

### PRIOR ART

U.S. Pat. No. 4,876,311 proposes the use of an opaque synthetic resin composition which contains 1-30% by weight of crosslinked beads. The beads are said to consist of a polymer comprising
(i) 9.9-59.9% by weight of at least one monomer which is capable of free radical polymerization and contains an aromatic radical, or of a nonaromatic monomer which contains a halogen,
(ii) 90-40% by weight of vinylic monomers which are copolymerizable therewith but are different from them,
(iii) 0.1-20% by weight of at least one crosslinking monomer and
(iv) 0-10% by weight of a strongly polar monomer.

Furthermore, the refractive index of the polymer is said to be greater than that of the polymer matrix and the mean particle size of the beads is said to be in the range of 20-50 μm.

The resin composition is extruded to give the desired mouldings.

Patent EP 1 022 115 describes extruded articles which have a matt and structured surface. In order to achieve this effect, light-scattering beads having a refractive index offset relative to the matrix of >0.02 are used. The weight average of the particle size of the beads is said to be in the range of 25-55 μm and the particles are said to have a particle size distribution in the range of 10-110 μm. The particular surface effect allegedly arises only through the use of beads having exactly this particle size distribution.

### OBJECT

It is the object of the present invention to provide possibilities for the production of mouldings having a matt and structured surface character, which have an improved property profile. Thus, as high a homogeneity as possible should be achieved. Inhomogeneities and optical defects, such as, for example, specks, should as far as possible be avoided. Furthermore, mechanical properties which are as good as possible were strived for. The roughness of the mouldings should as far as possible be improved. In addition, a substantial improvement in the weathering resistance was desired. Furthermore, a solution which can be realized on an industrial scale and economically in a comparatively simple manner was strived for.

### ACHIEVEMENT

This and further objects which are not specifically mentioned but which arise in an obvious manner from the relationships discussed in the introduction are achieved by a composition having all properties of the present Patent Claim 1. The subclaims relating back to Claim 1 describe particularly expedient modifications of the composition. Furthermore, the mouldings obtainable from the composition and particularly advantageous fields of use of the mouldings are protected.

By providing a composition for the production of mouldings having a matt and structured surface character, which composition comprises a polymer matrix and crosslinked polymer particles, the composition containing
(i) first crosslinked polymer particles having a weight average of the particle size in the range of 30 μm-1500 μm and
(ii) second crosslinked polymer particles having a weight average of the particle size of less than 30 μm,
   the difference between the refractive index of the first polymer particles and the refractive index of the polymer matrix, measured in each case at 25° C., being less than 0.015 as an absolute value and the difference between the refractive index of the second polymer particles and the refractive index of the polymer matrix, measured in each case at 25° C., being greater than or equal to 0.015 as an absolute value, it is possible in a manner not directly foreseeable to provide a composition for the production of mouldings having a matt and structured surface character, which have an improved property profile. Thus, the mouldings obtainable according to the invention are distinguished by a very high homogeneity, in particular with regard to the mechanical and the optical properties. Inhomogeneities and optical defects, such as, for example specks, are not observed. Furthermore, the mouldings obtainable according to the invention have very good mechanical properties, a very high roughness and significantly improved weathering resistance. The production of the mouldings according to the invention having a matt and structured surface character can be effected in a comparatively simple manner by the forming of the composition according to the invention.

The composition according to the invention contains a polymer matrix as the continuous phase. Suitable matrix polymers are all thermoplastically processable polymers which are known for this purpose. These include, inter alia, polyalkyl (meth)acrylates, such as, for example, polymethyl methacrylate (PMMA), polyacrylonitriles, polystyrenes, polyethers, polyesters, polycarbonates, polyvinyl chlorides. Polyalkyl (meth)acrylates are preferred here. These polymers can be used individually and as a mixture. Furthermore, these polymers may also be present in the form of copolymers.

In the context of the present invention, homo- and copolymers of C₁-C₁₅-alkyl (meth)acrylates, expediently of C₁-C₁₀-alkyl (meth)acrylates, in particular of C₁-C₄-alkyl (meth)acrylate polymers which may optionally also contain monomer units differing therefrom, are particularly preferred.

Here, the notation (meth)acrylate means both methacrylate, such as, for example, methyl methacrylate, ethyl methacrylate etc., and acrylate, such as, for example, methyl acrylate, ethyl acrylate, etc., and mixtures of the two monomers.

The use of copolymers which contain 70% by weight to 99% by weight, in particular 70% by weight to 90% by weight, of C₁-C₁₀-alkyl (meth)acrylates has proved to be very particularly useful. Preferred C₁-C₁₀-alkyl methacrylates comprise methyl methacrylate, ethyl methacrylate, propyl methacrylate, isopropyl methacrylate, n-butyl methacrylate, isobutyl methacrylate, tert-butyl methacrylate, pentyl methacrylate, hexyl methacrylate, heptyl methacrylate, octyl methacrylate, isooctyl methacrylate and ethylhexyl methacrylate, nonyl methacrylate, decyl methacrylate and cycloalkyl methacrylates, such as, for example, cyclohexyl methacrylate, isobornyl methacrylate or ethylcyclohexyl methacrylate. Preferred C₁-C₁₀-alkyl acrylates comprise methyl acrylate, ethyl acrylate, propyl acrylate, isopropyl acrylate, n-butyl acrylate, isobutyl acrylate, tert-butyl acrylate, pentyl acrylate, hexyl acrylate, heptyl acrylate, octyl acrylate, isooctyl acrylate, nonyl acrylate, decyl acrylate and ethylhexyl acrylate and cycloalkyl acrylates, such as, for example, cyclohexyl acrylate, isobornyl acrylate or ethylcyclohexyl acrylate.

Very particularly preferred copolymers comprise 80% by weight to 99% by weight of MMA units and 1% by weight to 20% by weight, preferably 1% by weight to 5% by weight, of C₁-C₁₀-alkyl acrylate units, in particular methyl acrylate and/or ethyl acrylate units. The use of the polymethyl methacrylate PLEXIGLAS® 7N obtainable from Evonik Röhm GmbH has proved to be very particularly useful in this context.

The matrix polymer can be prepared by polymerization processes known per se, free radical polymerization processes, in particular mass, solution, suspension and emulsion polymerization processes, being particularly preferred. Initiators particularly suitable for these purposes comprise in particular azo compounds, such as 2,2′-azobisisobutyronitrile or 2,2′-azobis(2,4-dimethylvaleronitrile), Redox systems, such as, for example, the combination of tertiary amines with peroxides or sodium disulphite and persulphates of potassium, sodium or ammonium or preferably peroxides (cf. in this context, for example H. Rauch-Puntigam, Th. Völker, “Acryl- und Methacrylverbindungen [Acrylic and Methacrylic Compounds]”, Springer, Heidelberg, 1967 or Kirk-Othmer, Encyclopedia of Chemical Technology, Vol. 1, page 386 et seq., J. Wiley, New York, 1978). Examples of suitable peroxide polymerization initiators are dilauroyl peroxide, tert-butyl peroctanoate, tert-butyl perisononanoate, dicyclohexyl peroxydicarbonate, dibenzoyl peroxide or 2,2-bis(tert-butylperoxy)butane. The polymerization can preferably also be carried out with a mixture of different polymerization initiators having different half-lives, for example dilauroyl peroxide and 2,2-bis(tert-butylperoxy)butane, in order to keep the free radical stream constant in the course of the polymerization and at different polymerization temperatures. The amounts of polymerization initiator used are in general 0.01% by weight to 2% by weight, based on the monomer mixture.

The polymerization can be carried out both continuously and batchwise. After the polymerization, the polymer is obtained via conventional isolation and separation steps, such as, for example, filtration, coagulation and spray drying, and is usually used in particulate form.

The chain lengths of the polymers or copolymers can be established by polymerization of the monomer or monomer mixture in the presence of molecular weight regulators, such as, in particular, of the mercaptans known for this purpose, such as, for example, n-butyl mercaptan, n-dodecyl mercaptan, 2-mercaptoethanol, methyl 3-mercaptopropionate or 2-ethylhexyl thioglycolate, pentaerythritol tetrathioglycolate; the molecular weight regulators being used in general in amounts of 0.05% by weight to 5% by weight, based on the monomer or monomer mixture, preferably in amounts of from 0.1% by weight to 2% by weight and particularly preferably in amounts of 0.2% by weight to 1% by weight, based on the monomer or monomer mixture (cf. for example H. Rauch-Puntigam, Th. Völker, “Acryl- und Methacrylverbindungen [Acrylic and Methacrylic Compounds]”, Springer, Heidelberg, 1967; Houben-Weyl, Methoden der organischen Chemie [Methods of Organic Chemistry], Vol. XIV/1, page 66, Georg Thieme, Heidelberg, 1961 or Kirk-Othmer, Encyclopedia of Chemical Technology, Vol. 1, page 296 et seq., J. Wiley, New York, 1978). n-Dodecyl mercaptan is preferably used as a molecular weight regulator.

The matrix may equally contain further additives well known to the person skilled in the art. Substances which modify the impact strength, external lubricants, antioxidants, flameproofing agents, UV stabilizers, flow improvers, metal additives for shielding against electromagnetic radiation, antistatic agents, demoulding agents, dyes, pigments, adhesion promoters, weathering stabilizers, plasticizers, fillers and the like are preferred.

The preparation of the impact-modifying substances is preferably effected by emulsion polymerization processes. In this way, a stable latex having an arithmetic weight average of the particle size in the range from 0.05 μm to 5 μm is obtained, which latex is usually spray-dried or coagulated/washed dry in order to isolate the polymer.

Emulsifiers suitable for these purposes are known to the person skilled in the art and comprise in particular customary soaps, alkylbenzenesulphonates, such as sodium dodecylbenzenesulphonates, alkyl phenoxypolyethylenesulphonates, sodium laurylsulphates, salts of long-chain amines, salts of long-chain carboxylic and sulphonic acids, etc. Particularly preferred emulsifiers comprise hydrocarbon groups having 8 to 22 carbon atoms, which are linked to highly polar, solubilizing groups, such as alkali metal and ammonium carboxylate groups, sulphate monoester groups, sulphonate groups, phosphate partial ester groups, etc.

The incorporation of the impact-modifying substances can be effected by subsequent mixing. However, it has proved to be particularly useful to add the impact-modifying substances before or during the preparation of the matrix polymer, such as, for example, by dispersing the impact-modifying substances in a monomer mixture which is used for the preparation of the matrix polymer or in a monomer/polymer syrup mixture, which together gives the desired matrix polymer. Equally, the impact-modifying substances can be introduced into a casting mixture in the form of an emulsion, suspension or dispersion in water or in an organic carrier. The water or the organic carrier can then be removed before or after the casting to give the final polymer form. The impact-modifying substances can also be compounded with the polymer by means of extrusion compounding. For further details regarding the addition of impact-modifying substances to matrix polymers, reference is made to U.S. Pat. No. 3,793,402.

A particularly preferred impact-modified matrix polymer is polymethyl methacrylate, which is commercially available from Evonik Röhm GmbH under the trade name Plexiglas® zk6BR.

The polymer matrix preferably has a light transmittance T_{D65} according to DIN 5033/7 in the range from 40% to 93%, preferably greater than 75%, in particular greater than 85%.

The content of the polymer matrix, based on the total weight of the composition, is advantageously 20.0% by weight to 95.0% by weight, preferably 30% by weight to 90% by weight, expediently 50% by weight to 89% by weight, in particular 70% by weight to 88% by weight.

In the present invention, the composition contains, in addition to the polymer matrix, also
(i) first polymer particles having a weight average of the particle size in the range from 30 μm to 1500 μm, preferably in the range from greater than 35 μm to 500 μm, in particular in the range from 40 μm to 150 μm, and
(ii) second polymer particles having a weight average of the particle size of less than 30 μm, preferably in the range from 1 μm to less than 30 μm, in particular in the range from 5 μm to 25 μm.

These polymer particles are preferably dispersed as homogenously as possible in the polymer matrix.

The stated values for the particle size are based in each case on the volume average of the particle size distribution. This particle size distribution can be determined, for example, by a Mastersizer 2000 from Malvern Instruments Ltd., the exact method of measurement for determining the particle size being contained in the user manual. The ISO 13320-1 standard is applicable here and the calculation is effected by the Fraunhofer model and Mie theory. The refractive index n²⁰ of 1.489 (PMMA) and the ABS_{coefficient} of 0 are specified as parameters. This method is preferred. In addition, the particle size can be determined by measuring and counting the particles on corresponding scanning electron micrographs.

Expediently, the first polymer particles have a narrow size distribution. Particularly preferably, the standard deviation of the averaged particle diameters is not more than 50 μm, very particularly preferably not more than 40 μm and in particular not more than 35 μm. The standard deviation of the averaged particle diameters of the second particles is preferably not more than 30 μm, expediently not more than 25 μm, in particular not more than 20 μm, even more preferably not more than 15 μm and extremely expediently not more than 12.5 μm.

In particularly preferred developments of the present invention, first and second polymer particles which do not coagulate, aggregate or agglomerate or do so only to a small extent are used. In the context of the invention, the statement “coagulate only to a small extent” is understood as meaning that, on incorporation of the particles into a polymeric matrix and subsequent processing by extrusion, no inhomogeneities or specks (point-like isolated elevations) occur on the surface of the moulding thus produced.

The refractive index of the polymer particles may be of very particular interest for achieving the aims according to the invention. The difference between the refractive index of the first polymer particles and the refractive index of the polymer matrix should advantageously be, as an absolute value, less than 0.015, preferably less than 0.013, expediently less than 0.01, in particular less than 0.007, even more preferably 0.005 or 0.0035 or 0.002. The difference between the refractive index of the second polymer particles and the refractive index of the polymer matrix should as far as possible be, as an absolute value, greater than or equal to 0.015, preferably greater than 0.016, expediently greater than 0.018, in particular greater than 0.02, very particularly preferably greater than 0.025, even more preferably greater than 0.03, greater than 0.033 or greater than 0.035.

The values for the refractive index are determined according to ISO 489 at λ=589.3 nm. Besides, the data are based on 25° C. This also applies to all other measured quantities referred to here unless another reference temperature is expressly specified.

In the context of the present invention, both the first and the second polymer particles are crosslinked. In this context, “crosslinked” means that the particles can be dissolved only in small amounts in a strong organic solvent, such as tetrahydrofuran (THF). Here, “small amount” means that the polymer-soluble fraction is not more than 7% by weight, based on the total weight of the particles used in the method of measurement. The polymer-soluble fraction is determined as follows:

the polymer particles are dissolved in THF and centrifuged for 3 hours at 21 000 rpm. In each case 15 ml of the supernatant are taken off and are made up again with about 15 ml of THF. This was repeated 3 times. The supernatant taken off is filtered through a 0.45 μm membrane filter, then reduced to 60 ml and centrifuged again for 3 hours. After the centrifuging, the supernatant is evaporated down and is analysed by means of NMR and GC-MS.

The crosslinking of the polymer particles is preferably achieved by copolymerization with suitable crosslinking monomers which usually have more than one unit capable of polymerization, preferably free radical polymerization, in the molecule. Those having at least two vinylic groups, in particular divinylbenzene, furthermore acrylates and methacrylates and acrylamides and methacrylamides of polyols, in particular glycol di(meth)acrylate, 1,3- and 1,4-butanediol (meth)acrylate, trimethylolpropane tri(meth)acrylate, tetraethylene glycol di(meth)acrylate, further monomers which contain vinylidene, (capped) amidomethylol, carbamide methylol ether, azlactone and epoxy groups, in particular N-methylol (meth)acrylamide, methylenebisacrylamide and methacrylamide, glycidyl (meth)acrylate, and also crosslinking monomers having unsaturated groups of graded reactivity in the molecule, in particular the vinyl, allyl and crotyl esters of acrylic and/or methacrylic acid, are preferred. Allyl methacrylate, divinylbenzene and/or ethylene glycol dimethacrylate are particularly preferably used. Further details of such monomers appear in H. Rauch-Puntigam, Th. Völker, Acryl- und Methacrylverbindungen [Acrylic and methacrylic compounds], Springer-Verlag Berlin, 1967.

The proportion of the crosslinking monomers, based on the total weight of the respective monomer mixture, is advantageously in the range from 0.1% by weight to 5.0% by weight, in particular in the range from 0.5% by weight to 1.5% by weight.

The crosslinking is intended, inter alia, to ensure that the particles do not melt during the processing at elevated temperature (up to about 300° C.).

Regarding their composition, the crosslinked particles are not subject to any particular limitations.

Polyalkyl (meth)acrylates are particularly preferred as first polymer particles. These polymers can be used individually and as a mixture. Furthermore, these polymers may also be present in the form of copolymers.

In the context of the present invention, homo- and copolymers of C₁-C₁₈-alkyl (meth)acrylates, expediently of C₁-C₁₀-alkyl (meth)acrylates, in particular of C₁-C₄-alkyl (meth)acrylate polymers, which optionally may also contain monomer units differing therefrom, are particularly preferred.

The use of copolymers which contain 70% by weight to 99% by weight, in particular 70% by weight to 90% by weight, of C₁-C₁₀-alkyl (meth)acrylates has proved to be very particularly useful. Preferred C₁-C₁₀-alkyl methacrylates comprise methyl methacrylate, ethyl methacrylate, propyl methacrylate, isopropyl methacrylate, n-butyl methacrylate, isobutyl methacrylate, tert-butyl methacrylate, pentyl methacrylate, hexyl methacrylate, heptyl methacrylate, octyl methacrylate, isooctyl methacrylate and ethylhexyl methacrylate, nonyl methacrylate, decyl methacrylate and cycloalkyl methacrylates, such as, for example, cyclohexyl methacrylate, isobornyl methacrylate or ethylcyclohexyl methacrylate. Preferred C₁-C₁₀-alkyl acrylates comprise methyl acrylate, ethyl acrylate, propyl acrylate, isopropyl acrylate, n-butyl acrylate, isobutyl acrylate, tert-butyl acrylate, pentyl acrylate, hexyl acrylate, heptyl acrylate, octyl acrylate, isooctyl acrylate, nonyl acrylate, decyl acrylate and ethylhexyl acrylate and cycloalkyl acrylates, such as, for example, cyclohexyl acrylate, isobornyl acrylate or ethylcyclohexyl acrylate.

Very particularly preferred copolymers comprise 80% by weight to 99% by weight of MMA units and 1% by weight to 20% by weight, preferably 1% by weight to 5% by weight, of C₁-C₁₀-alkyl acrylate units, in particular methyl acrylate and/or ethyl acrylate units.

The use of second polymer particles which contain at least one monomer which is capable of free radical polymerization and comprises at least one aromatic radical is furthermore particularly preferred. Said radicals are preferably styrene and its methyl-substituted derivatives, such as alpha-methyl and p-methylstyrene, p-ethylstyrene, and halogenated derivatives of styrene, such as p-chlorostyrene. Furthermore, phenyl acrylate and methacrylate, xylylene methacrylate and acrylate, in particular in the m-form, 4-methylphenyl acrylate and methacrylate, 2-phenylethyl acrylate and methacrylate, 3-phenyl-1-propyl methacrylate and acrylate, 2-phenyloxyethyl acrylate and methacrylate and benzyl methacrylate are furthermore preferred as monomer A of the formula (I). The proportion of the aromatic monomers is preferably greater than 50% by weight, based on the total weight of the first polymer particles.

A detailed description of the preparation of such particles is to be found, for example, in EP1219641, Example 2. Reference is hereby made to this document for the purpose of disclosure.

Furthermore particularly expediently used as second polymer particles are those which are commercially available under the name “Techpolymer® SBX8” from the manufacturer Sekisui Chemical Co. Ltd., Japan. These are polymer particles which consist of crosslinked polystyrene and have a volume average of the particle size of 6 to 10 μm.

The composition of the polymer particles can be determined by means of a pyrolysis GC/MS spectrometer, the polymer material being pyrolysed at an elevated temperature and the decomposed constituents being further analysed for quantitative determination.

Suspension polymerization processes (bead polymerizations) have proved to be very particularly useful for the preparation of the polymer particles. In this process, the monomers are distributed as the disperse phase by the action of mechanical forces (stirring) in a nonsolvent (continuous phase) and are polymerized in this form. The polymer formed is predominantly soluble in the monomer. Under the influence of the surface tension, the monomer forms spherical drops. In order to retain the drop shape during the polymerization and to prevent the coalescence of drops, so-called “dispersants” or distributors (protective colloids), preferably substances which can be completely separated off from the polymer obtained in bead form after the end of the polymerization, are added to the polymerization batch.

The “distributor” ensures that the monomer droplets, once formed, are stabilized to such an extent that combination of drops is practically absent.

As a rule, water is used as the continuous phase. Primarily sparingly soluble to water-insoluble monomers capable of free radical polymerization are therefore suitable as monomers suitable for the polymerization. (cf. Houben-Weyl, 4th edition, Vol. XIV/1 “Makromolekulare Stoffe [Macromolecular Substances]”, pages 406-433, G. Thieme Verlag 1961.)

Distributors used are preferably (water insoluble) salts of inorganic acids, such as barium sulphate or barium carbonate, or high molecular weight natural substances or synthetic polymers. The group consisting of the high molecular weight distributors includes water-soluble colloids, such as polyvinyl alcohol, partly hydrolysed polyvinyl acetate, methylcellulose, starch, gelatin, pectin, the alkali metal salts of polyacrylic acid or the alkali metal salts of styrene- or vinyl acetate-maleic anhydride copolymers, etc. (cf. Houben-Weyl, loc. cit. pages 411-430.) The ratio of the aqueous phase to the monomer phase is preferably 2:1 to 4:1.

It is known that initiators which are soluble to a first approximation in the monomers but insoluble in water are used in the bead polymerization. In general, the amount of initiator used is 0.1% by weight to 1% by weight, preferably about 0.5% by weight, based on the monomers. Preferably used initiators are the customary organic peroxides soluble in the monomer or corresponding azo compounds, such as, for example, dibenzoyl peroxide, lauroyl peroxide, azoisobutyronitrile. Free radical formers having higher decomposition temperatures can additionally be used if the temperature is increased towards the end of the reaction for polymerization which is as complete as possible. The bead size can be adjusted within the claimed range.

Furthermore, the lubricants usually used, such as fatty alcohols, stearic acid esters, palmitic acid esters or natural waxes may be added—preferably before the polymerization.

The polymerization can be carried out in practice by initially introducing the water, the monomers, initiator, dispersants and optionally lubricant together and then heating, for example to about 90° C. Optionally the excess heat of polymerization, in particular from 95° C., is removed by external cooling. Temperatures above 115° C. should as far as possible be avoided. The duration of the polymerization is usually in the range from 1 to 5 hours. The viscosity of the polymerization batch (measured using a Brookfield viscometer at the polymerization temperature) is in general in the range between 800 mPa·s and 8000 mPa·s.

The lubricants, some of which are reactive, are preferably added only from a conversion of about 20%. The addition of regulators can also be effected in the course of the polymerization.

After the end of the reaction, the beads are generally separated off by filtration or centrifuging. Adhering additives can be removed in a suitable manner, for example by washing with dilute acid and water. The beads are frequently dried with heating, preferably with air circulation, e.g. in tray dryers.

It is within the scope of the present invention to dye or colour the crosslinked particles during the suspension process. The advantages of using dyed or coloured particles compared with a coloured matrix material are flexibility with regard to production, reduction of costs, better colour distribution, reduced surface gloss, deep and natural colour distribution and a reduced cleaning effort in the case of the production of different products.

The introduction of the crosslinked polymer particles into the composition according to the invention can be effected by mixing the components, the constituents preferably being distributed homogeneously in the composition.

The content of the first polymer particles, based on the total weight of the composition, is advantageously 0.1% by weight to 20.0% by weight, preferably 1% by weight to 18% by weight, expediently 3.0% by weight to 15.0% by weight, in particular 4.0% by weight to 12.0% by weight.

The content of the second polymer particles, based on the total weight of the composition, is advantageously 0.1% by weight to 20.0% by weight, preferably 0.2% by weight to 18.0% by weight, expediently 0.3% by weight to 14.0% by weight, in particular 0.4% by weight to 10.0% by weight.

The composition can be further processed, in particular formed, like conventional thermoplastics to give different end products. Preferred forming processes comprise profile extrusion, slab and sheet extrusion, injection moulding and transfer moulding. The product resulting from the slab, sheet or profile extrusion has a structured surface and a matt appearance without special patterned rollers, rolls or polishing or grinding apparatuses being required. The product which is obtained by injection moulding has a matt appearance.

The expression “structured surface” as used here describes a surface having the following roughness:
The centre line average value Ra is at least 1.0 μm, preferably at least 2.7 μm, in particular at least 4.55 μm.
The averaged peak-to-valley height Rz is at least 10 μm, preferably at least 22 μm, in particular at least 31 μm.
The peak-to-valley height Rt is at least 20 μm, preferably at least 28 μm, in particular at least 38 μm.

The surface roughness is determined according to DIN EN ISO 4287 and DIN EN ISO 4288.

One of the advantages of the present invention is that the total white light transmission (TWLT) is much greater than in the case of similar commercial products which are provided with inorganic fillers, such as barium sulphate or colour concentrate, for achieving a matt appearance. For example, PMMA pigmented with barium sulphate has a TWLT value of 47% whereas TWLT values of above 80% can be achieved according to the invention. The TWLT value is measured according to ASTM: E1331 and E1164, preferably with the use of a Hunterlab colorimeter D25 model.

The matt appearance can be determined by means of an opacity or light opacity measurement (turbidity measurement). The higher the opacity value, the better the hiding power or the power of masking identity. In order to achieve a matt appearance, the opacity should be at least 10%. The polymer particle load and the difference between the refractive indices influence the hiding power of the sample, which is expressed by the opacity number. The determination of the opacity values is preferably effected according to the standards ASTM D2805-80, ASTM D589-65, TAPPI T-425 and TAPPI T-519.

The composition according to the invention and the mouldings obtainable therefrom preferably have a light transmittance T_{D65} according to DIN 5033/7 of at least 50%, preferably of at least 55%, particularly preferably of at least 70%, in particular in the range from 80% to less than 90%.

Mouldings obtainable from the compositions according to the invention preferably have a half-intensity angle (HIA), measured according to DIN 5036 using a GO-T-1500 goniometer test unit from LMT, in the range of greater than 5° and less than 60°. HIA values in the range of greater than 10° and less than 50° are particularly expedient. Values in the range of greater than 15° and less than 45° are very particularly expedient and values for HIA in the range of greater than 20° and less than 40° are even more preferred.

The tensile strength (ISO 527) of mouldings obtainable from the composition is preferably at least 20 MPa, preferably at least 40 MPa, particularly preferably at least 50 MPa, in particular at least 60 MPa.

The modulus of elasticity of mouldings obtainable from the composition according to ISO 527 is advantageously greater than 1600 MPa, preferably greater than 1700 MPa, with the use of impact-resistant polymer matrices.

The Charpy impact strength, according to ISO 179, of mouldings obtainable from the composition is preferably at least 30 kJ/m², preferably at least 40 kJ/m², in particular at least 50 kJ/m², with the use of impact-resistant polymer matrices.

The tensile strain at yield, according to ISO 527, of mouldings obtainable from the composition is advantageously greater than 3%, preferably greater than 4%.

The tensile strain at break, according to ISO 527, of mouldings obtainable from the composition is preferably at least 2% and, with the use of impact-resistant polymer matrices, preferably at least 15%, in particular at least 30%.

The Vicat softening temperature VET (ISO 306-B50) of the composition according to the invention and of the mouldings obtainable therefrom is preferably at least 95° C., preferably at least 97° C., particularly preferably at least 103° C., in particular greater than 104° C., with the use of non-impact-resistant polymer matrices.

The melt volume flow rate MVR (ISO 1133, 230° C./3.8 kg) of the composition according to the invention and of the mouldings obtainable therefrom is preferably at least 1.0 cm³/10 min, preferably at least 1.3 cm³/10 min, with the use of impact-resistant polymer matrices and particularly preferably at least 3.0 cm³/10 min, in particular at least 4.5 cm³/10 min, with the use of non-impact-resistant polymer matrices.

The mouldings obtainable according to the invention can be used in particular for lighting, signs or symbols, points-of-sale and cosmetic display stands, containers, home and office decorations, furniture applications, shower cabinet doors and office doors. The invention is further explained by the following examples and comparative examples without it being intended to limit the concept of the invention thereby.

The Following Materials were Used:

### A1) Matrix 1

Glass-clear PLEXIGLAS zk6BR from Evonik Röhm GmbH was used as matrix 1. The refractive index of the material was 1.4933 (n_{D}²⁵).

### A2) Matrix 2

Glass-clear PLEXIGLAS 7N from Evonik Röhm GmbH was used as matrix 2. The refractive index of the material was 1.4939 (n_{D}²⁵).

### B1) Bead Polymer 1 (=Bead 1)

In a 100 I V4A steel reactor which was provided with a nitrogen inlet and a paddle stirrer, 600 g of Al₂(SO₄)₃.18H₂O and 6 g of sodium paraffinsulphonate were dissolved in 50 I of demineralized water at 85° C. by stirring at 350 rpm. The aluminium compound used as a dispersant was precipitated by addition of 264 g of sodium carbonate.

A monomer mixture comprising 5.9 kg of methyl methacrylate, 4.0 kg of styrene and 0.1 kg of glycol dimethacrylate and 0.2 kg of dilauroyl peroxide was then added under nitrogen. The polymerization was carried out at 80° C. for 140 minutes and then at 90° C. for 60 minutes with stirring. The polymerization mixture was then cooled to 50° C. and treated with 600 ml of sulphuric acid (50%) in order to dissolve the dispersant. The beads were filtered off, washed with demineralized water and dried for 20 hours at 50° C.

The volume average of the particle size was 39.7 μm, the particle size standard deviation was 11 μm and the refractive index of the beads was 1.5248 (n_{D}²⁵).

### C1) Bead Polymer 2 (=Bead 2)

For preparation, cf. EP 1219641, Example 2

The volume average of the particle size was 20.4 μm, the particle size standard deviation was 8.4 μm and the refractive index of the beads was 1.5174 (n_{D}²⁵).

### B2) Bead Polymer 3 (=Bead 3)

In a 15 I V2A steel reactor which was provided with a nitrogen inlet and a propeller stirrer, 94.5 g of Al₂(SO₄)₃.14H₂O were dissolved in 8127.0 ml of demineralized water at 40° C. by stirring at 220 rpm. The aluminium compound was then precipitated by addition of 378 g of 10% strength sodium carbonate solution. This was followed by the addition of 0.47 g of sodium C₁₅-paraffinsulphonate and of 0.47 g of lubricant as a 1% strength solution. The pH of the aqueous phase was about 5-5.5.

A mixture of 1795.5 g of methyl methacrylate, 75.6 g of ethyl acrylate and 18.9 g of glycol dimethacrylate and 37.8 g of dilauroyl peroxide, 3.78 g of tert-butyl per-2-ethylhexanoate and 5.67 g of tert-dodecyl mercaptan was then added under nitrogen. The polymerization was carried out at 90° C. for 60 minutes with stirring (220 rpm). The polymerization mixture was then cooled to 40° C. and acidified with 29 ml of sulphuric acid (50%). The beads were filtered off, washed with demineralized water and dried for 20 hours at 50° C.

The volume average of the particle size was 43.1 μm, the particle size standard deviation was 26.7 μm and the refractive index of the beads was 1.4888 (n_{D}²⁵).

### C2) Bead Polymer 4 (=Bead 4)

A crosslinked polystyrene bead obtainable under the name Techpolymer® SBX-8 from the manufacturer Sekisui Chemical Co. Ltd., Japan, and having an average particle diameter of 8 μm was used. The volume average of the particle size was 8.2 μm, the particle size standard deviation was 3.1 μm and the refractive index of the beads was 1.5891 (n_{D}²⁵).

The components were mixed with one another and investigated with regard to their properties. The proportions of the respective components are shown in Table 1.

TABLE 1
Compositions (proportions by weight in brackets)

| | | Bead with | Bead with |
|---|---|---|---|
| | Matrix | Δn > 0.015 | Δn < 0.015 |
| B 1 | Matrix 1 (90) | Bead 2 (4) | Bead 3 (6) |
| B 2 | Matrix 1 (83) | Bead 2 (7) | Bead 3 (10) |
| B 3 | Matrix 1 (93.5) | Bead 4 (0.5) | Bead 3 (6) |
| B 4 | Matrix 1 (87) | Bead 4 (1) | Bead 3 (12) |
| B 5 | Matrix 2 (83) | Bead 2 (7) | Bead 3 (10) |
| B 6 | Matrix 2 (87) | Bead 4 (1) | Bead 3 (12) |
| VB 1 | Matrix 1 (94) | Bead 1 (6) | — |
| VB 2 | Matrix 1 (88) | Bead 1 (12) | — |
| VB 3 | Matrix 2 (94) | Bead 1 (6) | — |
| VB 4 | Matrix 2 (88) | Bead 1 (12) | — |

The individual components were mixed by means of a single-screw extruder.

The melt volume flow rate MVR (test standard ISO 1133: 1997) was determined.

Test specimens were produced from the mixed moulding materials by injection moulding and strip extrusion. In the processing, metal abrasion was found neither during the strip extrusion nor during the injection moulding. The corresponding test specimens were tested by the following methods:

| | |
|---|---|
| Vicat (16 h/80° C.): | Determination of the Vicat softening |
| | temperature (test standard DIN ISO 306: |
| | August 1994) |
| IS (Charpy 179/1eU): | Determination of the Charpy impact strength |
| | (test standard: ISO 179: 1993) |
| Modulus of elasticity: | Determination of the modulus of elasticity |
| | (test standard: ISO 527-2) |
| Tensile strength: | Determination of the tensile stress at break |
| | (test standard: ISO 527; 5 mm/min), and of |
| | the tensile stress at yield (test standard: |
| | ISO 527; 50 mm/min) |
| Tensile strain at yield: | Determination of the tensile strain at yield |
| | (test standard: ISO 527; 50 mm/min) |
| Tensile strain at break: | Determination of the (nominal) tensile strain |
| | at break (test standard: ISO 527) |
| Transmittance (T): | according to DIN 5036 |
| Half-intensity angle | measured according to DIN 5036 using a |
| (HIA): | GO-T-1500 goniometer test unit from LMT |
| Surface roughness: | roughness parameters Ra, Rz and Rt |
| | according to DIN 4768. Ra values <2 μm |
| | were determined with a cut-off of 0.8 mm and |
| | in the case of Ra ≧2 μm with a cut-off of |
| | 2.5 mm. The roughness measurements were |
| | carried out using a Form Talysurf 50; the |
| | manufacturer is Rank Taylor Hobson GmbH. |

Table 2 summarizes the results obtained. It is evident that mouldings having a matt and structured surface character are obtained by the solution according to the invention. The roughness of the mouldings is increased and at the same time they scatter the light very well with little energy loss.

TABLE 2

| | B1 | B2 | B3 | B4 | B5 | B6 | VB1 | VB2 | VB3 | VB4 |
|---|---|---|---|---|---|---|---|---|---|---|
| Light transmittance | 87.8 | 82.7 | 72 | 57.3 | 84.3 | 57 | 87.4 | 81.8 | 87.8 | 80 |
| (D65/10) [%] | | | | | | | | | | |
| Half-intensity angle | 13.7 | 21 | 11.4 | 41.5 | 20.7 | 45.2 | 12.3 | 20.7 | 13.9 | 24.2 |
| Scattering power | | | | | | | | | | |
| Centre line average value | 2.74 | 4.83 | 3.33 | 4.81 | 4.41 | 4.24 | 2.64 | 4.52 | 2.35 | 3.59 |
| Ra (2.5 mm) [μm] | | | | | | | | | | |
| Averaged peak-to-valley | 22.4 | 37.66 | 27.59 | 33.7 | 31.95 | 29.79 | 21.32 | 30.31 | 18.11 | 25.85 |
| height Rz | | | | | | | | | | |
| (2.5 mm) [μm] | | | | | | | | | | |
| Peak-to-valley height Rt | 28.86 | 50.01 | 36.14 | 43.71 | 40.15 | 37.4 | 27.64 | 37.4 | 23.25 | 32.27 |
| (2.5 mm) [μm] | | | | | | | | | | |
| Charpy impact strength | | 34.3 | | 32.6 | | | | 58.3 | | |
| [MPa] | | | | | | | | | | |
| Tensile strength | | 45.8* | | 47* | 59.7 | 63.7 | | 46.5* | | 59.6 |
| (brittle 5 mm/min, | | | | | | | | | | |
| tough (*) 50 mm/min) [MPa] | | | | | | | | | | |
| Modulus of elasticity | | 1983* | | 1905* | 3330 | 3297 | | 1904* | | 3311 |
| (brittle 5 mm/min, | | | | | | | | | | |
| tough (*) 50 mm/min) | | | | | | | | | | |
| [MPa] | | | | | | | | | | |
| Tensile strain at yield | | 3.8 | | 4.3 | — | — | | 4.2 | | — |
| (tough 50 mm/min) [%] | | | | | | | | | | |
| Tensile strain at break | | 15.1* | | 17* | 2.4 | 2.8 | | 37.3* | | 2.3 |
| (brittle 5 mm/min, | | | | | | | | | | |
| tough (*) 50 mm/min) [%] | | | | | | | | | | |
| Vicat | 97.4 | 96.9 | 98 | 98.9 | 103.2 | 104.9 | 98.3 | 98.5 | 103.9 | 103.9 |
| (16 h/80° C.) [° C.] | | | | | | | | | | |
| MVR | 1.4 | 1.1 | 1.4 | 1.3 | 4.6 | 4.9 | 1.4 | 1.3 | 5.6 | 5.2 |
| (230° C.; 3.8 kg) | | | | | | | | | | |
| [cm³/10 min] | | | | | | | | | | |

1. A composition comprising a polymer matrix and crosslinked polymer particles, wherein the composition comprises
(i) a first crosslinked polymer particle having a volume average of the particle size in the range of from 30 μm to 1500 μm and
(ii) a second crosslinked polymer particle having a volume average of the particle size of less than 30 μm,
wherein the difference between the refractive index of the first crosslinked polymer particle and the refractive index of the polymer matrix, measured in each case at 25° C., is less than 0.015 as an absolute value and the difference between the refractive index of the second crosslinked polymer particle and the refractive index of the polymer matrix, measured at 25° C., is greater than or equal to 0.015 as an absolute value.

2. The composition according to claim 1, wherein the first crosslinked polymer particle has a volume average of the particle size in the range of from 35 μm to 500 μm.

3. The composition according to claim 2, wherein the first crosslinked polymer particle has a volume average of the particle size in the range of from 40 μm to 150 μm.

4. The composition according to claim 1, wherein the second crosslinked polymer particle has a volume average of the particle size in the range of from 1 μm to less than 30 μm.

5. The composition according to claim 4, wherein the second crosslinked polymer particle has a volume average of the particle size in the range of from 5 μm to 25 μm.

6. The composition according to claim 1, wherein the difference between the refractive indices of the polymer matrix and first crosslinked polymer particle, measured at 25° C., is less than 0.01 as an absolute value.

7. The composition according to claim 1, wherein the matrix polymer comprises a homo-polymer and a copolymer of C₁-C₁₈-alkyl (meth)acrylates, wherein the homo-polymer or the copolymer may optionally also comprise monomer units differing therefrom.

8. The composition according to claim 1, wherein the first crosslinked polymer particle comprises a homo-polymer or a copolymer of C₁-C₁₈-alkyl (meth)acrylates, wherein the homo-polymer or the copolymer may optionally also contain monomer units differing therefrom.

9. The composition according to claim 1, wherein the second crosslinked polymer particle comprises repeating units which have at least one aromatic radical.

10. The composition according to claim 1, wherein the first crosslinked polymer particle or second crosslinked polymer particle, or both, is obtained by a process comprising crosslinking with allyl methacrylate, divinylbenzene or ethylene glycol dimethacrylate, or mixtures thereof.

11. The composition according to claim 1, comprising, based in each case on their total weight,
20.0% by weight to 90% by weight of a polymer matrix,
0.1% by weight to 20.0% by weight of a first crosslinked polymer particle and
0.1% by weight to 20.0% by weight of a second crosslinked polymer particle.

12. A moulding having a matt and structured surface character, obtained by a process comprising forming a composition according to claim 1.

13. The mouldings according to claim 12, obtained by a process comprising extruding a composition according to claim 1.

14. The mouldings according to claim 12, having a half-intensity angle at 3 mm thickness of at least 10% and an averaged peak-to-valley height Rz of at least 10 μm.

15. (canceled)
